(19) United States
(12) Patent Application Publication
(10) Pub. No.: US 2021/0213681 A1
(43) Pub. Date: Jul. 15, 2021

(54) Filament Dry Box

(71) Applicant: STACKER, LLC, Golden Valley, MN (US)

(72) Inventor: Norston L. Fontaine, Golden Valley, MN (US)

(73) Assignee: STACKER, LLC, Golden Valley, MN (US)

(21) Appl. No.: 17/143,529

(22) Filed: Jan. 7, 2021

Related U.S. Application Data
(60) Provisional application No. 62/959,069, filed on Jan. 9, 2020.

(51) Int. Cl. B29C 64/255; B33Y 30/00; B65H 49/04

(52) U.S. Cl. CPC B29C 64/255; B65H 2515/805; B65H 49/04; B33Y 30/00

(57) ABSTRACT

Apparatus and associated methods relate to a filament dispensing dry box defining a cavity sealed from ambient atmosphere external to the dry box, the cavity being configured to receive at least one spool of filament for deposition. In an illustrative example, the cavity may be provided with at least one replaceable desiccant cartridge. The cavity may, for example, be defined by a lid, hingedly coupled to a base. The cavity may be sealed, for example, by a sealing element between the lid and the base. The cavity may, for example, have a filament egress aperture configured to slidingly seal to the filament. The cavity may have, for example, a lumen through the lid and the base configured to slidingly receive a spindle for supporting the dry box. Various embodiments may advantageously dispense filament from a dry environment.

### CROSS-REFERENCE TO RELATED APPLICATIONS

This application claims the benefit of U.S. Provisional Application Ser. No. 62/959,069, titled “FILAMENT DRY BOX,” filed by Norston Fontaine on Jan. 9, 2020.

This application incorporates the entire contents of the foregoing application(s) herein by reference.

### TECHNICAL FIELD

Various embodiments relate generally to filament dry boxes.

### BACKGROUND

Prototypes for mechanical designs are used by engineers during product development. Engineers can test how a part will fit or operate by building a prototype. Prototypes can reveal things that were unanticipated by the designer. Some prototypes are made to as a miniaturized model so as to be less unwieldy or less expensive. Still, even miniaturized prototypes can be instructive to the designer or user. Prototypes can be used to test how a hand-held device will feel in the hands of a user. Prototypes can facilitate the development of a part that must interface with another part. For example, a prototype may be given to a vendor who has contracted to make a part to which the prototype may couple.

Three-dimensional (3D) printing can be performed to produce prototypes of designs. 3D printers may use fused deposition modeling to deposit materials. In fused deposition modeling, a part may be produced by extruding small diameter beads of liquid material that harden soon after deposition. 3D printers may use granular materials binding methods that selectively fuse materials in a granular bed. Layers of granules are added to the granular bed, and the fusing process is then repeated. Lamination techniques have been used by 3D printers to adhere layers of paper or other material in layers.

### SUMMARY

Apparatus and associated methods relate to a filament dispensing dry box defining a cavity sealed from ambient atmosphere external to the dry box, the cavity being configured to receive at least one spool of filament for deposition. In an illustrative example, the cavity may be provided with at least one replaceable desiccant cartridge. The cavity may, for example, be defined by a lid, hingedly coupled to a base. The cavity may be sealed, for example, by a sealing element between the lid and the base. The cavity may, for example, have a filament egress aperture configured to slidingly seal to the filament. The cavity may have, for example, a lumen through the lid and the base configured to slidingly receive a spindle for supporting the dry box. Various embodiments may advantageously dispense filament from a dry environment.

Various embodiments may achieve one or more advantages. For example, some embodiments may advantageously provide a dry environment for storage and/or dispensing of filament. Various embodiments may advantageously provide rechargeable desiccant cartridges. Various embodiments may advantageously rotationally engage a mounting spindle. Various embodiments may advantageously stack in a compact manner. Various embodiments may advantageously provide visibility of filament singly, in a stacked configuration, in a dispensing configuration, or some combination thereof. Various embodiments may advantageously receive a plurality of filament spools.

The details of various embodiments are set forth in the accompanying drawings and the description below. Other features and advantages will be apparent from the description and drawings, and from the claims.

### BRIEF DESCRIPTION OF THE DRAWINGS

FIG. 1A shows an exemplary filament dry box containing a filament spool and FIG. 1B shows an exemplary filament dry box with a transparent lid and containing a filament spool.

FIG. 2 shows an exemplary filament dry box with a desiccant pack.

FIG. 3 depicts a front view of an exemplary filament dry box configured with an exemplary heating device.

FIG. 4A depicts the exemplary filament dry box mounted on an exemplary 3D printer.

FIG. 4B depicts the exemplary filament dry box mounted on another exemplary 3D printer, with exemplary filament dry boxes stacked up.

FIG. 5 is a front, top, and right perspective view of the filament dry box.

FIG. 6 is a front elevation view of the filament dry box of FIG. 5.

FIG. 7 is a right side elevation view of the filament dry box of FIG. 5.

FIG. 8 is a back side elevation view of the filament dry box of FIG. 5.

FIG. 9 is a left side elevation view of the filament dry box of FIG. 5.

FIG. 10 is a top plan view of the filament dry box of FIG. 5.

FIG. 11 is a bottom plan view of the filament dry box of FIG. 5.

FIG. 12 depicts a front elevation view of another exemplary filament dry box having a built-in desiccant recharging system in a closed state.

FIG. 13 is a front, top, and right perspective view of the exemplary filament dry box described with reference to FIG. 12.

FIG. 14 depicts an exemplary circulatory path in the exemplary filament dry box described with reference to FIG. 12.

Like reference symbols in the various drawings indicate like elements.

### DETAILED DESCRIPTION OF ILLUSTRATIVE EMBODIMENTS

In various embodiments, filaments used in 3D printing may include thermoplastics, which are plastics (e.g., polymers) that melt rather than burn when heated. The thermoplastics may be shaped and molded and solidify when cooled. The filament may be fed into a heating chamber in the printer's extruder assembly, where it is heated to its melting point and then extruded (squirted) through a metal nozzle as the extruder assembly moves, tracing a path programmed into a 3D object file to create, layer by layer, the printed object. The process of printing with plastic filament may be called fused filament fabrication (FFF) or fused deposition modeling (FDM). Plastic polymers are made of chains of molecules strung together. Most FDM 3D printing filaments are hygroscopic. Moisture introduces water molecules that break up these chains, ruining the plastic (e.g., weakening the layers and making a bubby or rough surface) and causing a whole slew of problems while printing.

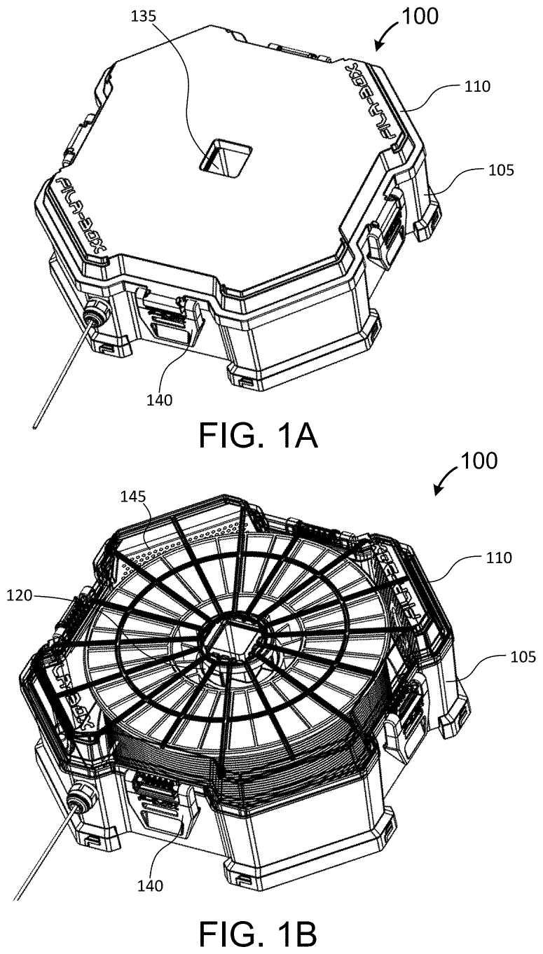

FIG. 1A shows an exemplary filament dry box containing a filament spool and FIG. 1B shows an exemplary filament dry box with a transparent lid and containing a filament spool. In this depicted example, an exemplary filament dry box 100 includes a base 105 and a mating lid 110 coupled to the base 105 to form a sealed cavity. The base 105 and/or the lid 110 may be transparent such that a user may, for example, identify the color of the filament and/or how much filament is left in the filament dry box without opening the lid 110. The filament dry box 100 also includes a number of coupling features (e.g., hinges) configured to couple the lid 110 to the base 105. The filament dry box 100 also includes a hub 120. The filament spool is placed over the hub 120 in the sealed cavity formed by the base 105 and the lid 110. In this depicted example, the filament dry box 100 also includes a square hole 135 on the lid 110. The square hole 135 may be aligned with the hub 120 such that the hub 120 may provide the bearing surface for the spool to rotate on while preventing the entire filament dry box 100 from rotating (e.g., keep the entire filament dry box stationary). The filament dry box 100 may be then mounted to a 3D printer through a filament spool holder (not shown). The filament spool holder may be coupled to the hub 120 through the square hole 135. By providing the filament dry box 100 with a hub that is compatible with the spool holder of a 3D printer, the filament dry box 100 may be mounted in situ on the 3D printer such that less moisture may be introduced during the dispensing process, as the distance between the filament dry box 100 and the 3D printer is shortened.

The filament dry box may have two states: open state and closed state. When the filament dry box is in the open state, the lid 110 may be opened, and a filament spool may be installed in the filament dry box 100 or removed from the filament dry box 100. When the filament dry box is in the closed state, the lid 110 may be closed, and the filament dry box may be then locked. Various locking mechanisms 140 may be used to provide the closed state of the filament dry box 100.

The filament dry box 100 also includes sealing mechanisms (e.g., sealing rubber) to further protect the filaments dispensed by the filament dry box 100 from the ambient environment when the filament dry box 100 is in the closed state. For example, in this depicted example, the filament dry box 100 includes a dispenser 125. The dispenser 125 may include a build-in sealing element to advantageously reduce or prevent leakage between the dispenser and the housing (e.g., the base 105 and the lid 110). In some embodiments, the dispenser 125 may also accept and seal against a tubing. In some embodiments, the dispenser 125 may be designed to work with a plastic tubing carrying, for example, air or water or both, such that the path between the box 100 and the printer may be isolated, and a completely sealed environment may be created. Filament 130 may be dispensed by the dispenser 125 and then used by the 3D printer. The dispenser 125 may also advantageously isolate the environment in the filament dry box 100 from the ambient environment such that the humidity in the filament dry box 100 may be not substantially affected by the ambient environment.

In some embodiments, the filament dry box 100 may also include desiccants 145. The desiccants 145 may be placed in one or more desiccant packs. The desiccants may be used to absorb moisture in the filament dry box 100. The desiccants 145 may also be used to indicate the humidity level of the environment in the filament dry box 100 and the humidity level of filaments. For example, in this depicted example, the desiccants 145 may change from orange to green when the desiccants 145 absorbs a predetermined amount of moisture.

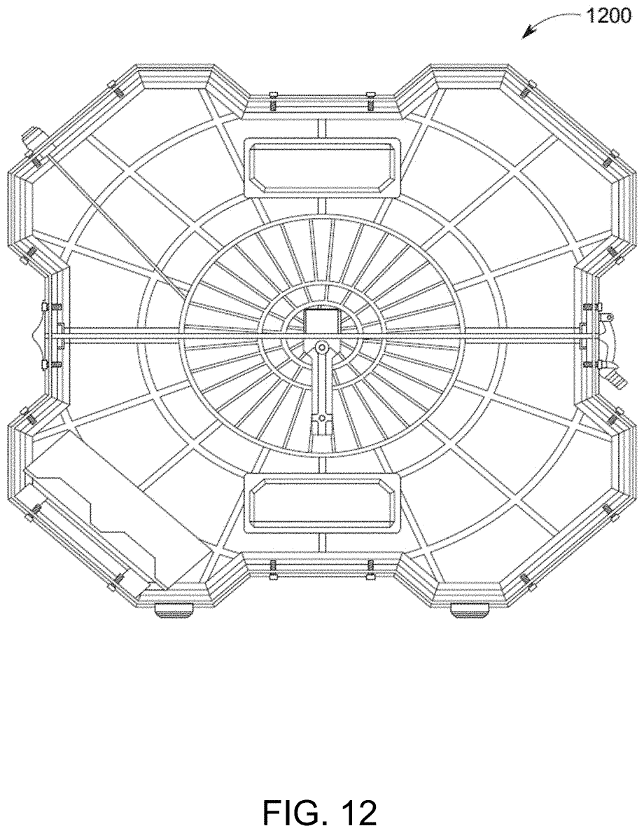

In some embodiments, the desiccants 145 may also be used to identify the humidity level achieves a predetermined threshold. The user may use some mechanisms to reduce the moisture by, for example, blowing warm air into the cavity of the filament dry box 100. By observing the color of the desiccants 145, a user may be able to tell the moisture content in the filament dry box 100. Depending on, for example, how wet the user's filament is, and how humid the environment is inside and outside the filament dry box 100, the desiccants may eventually become saturated and need to be recharged. In some embodiments, the desiccants 145 in the desiccant packs may be recharged in, for example, an oven, microwave, toaster, food dehydrator, and/or dehumidifier, for a duration of time (e.g., a couple of hours). In some embodiments, the desiccants 145 may be recharged in the filament dry box. An exemplary architecture of a filament dry box with built-in desiccant recharging system is discussed in detail with reference to FIGS. 12-15. The temperature for recharging the desiccants may be, for example, 120° C. to 200° C. Hot air may also be pumped into the filament dry box 100 via, for example, a small forced air heater, heat gun, or blow dryer type device (either directly mounted or via a duct or a hose), to recharge the desiccants 145. The temperature for recharging the desiccants may be, for example, below the filament dry box's heat deflection temperature. After recharging, the desiccants 145 may then change from green to orange and be able to indicate the moisture level again. There may be no limit on how many times the desiccants 145 can be recharged.

In some embodiments, the shape of the hole 135 may be designed as, for example, triangle, hexagonal, or irregular (e.g., D-shape), to be compatible with the filament spool holder of the 3D printer. In some embodiments, as the filament dry box 100 is able to mount on the 3D printer, the transportation of the 3D printer and the filament dry box 100 may be simplified. In addition, the footprint consumed by the 3D printer and the filament dry box 100 may be reduced.

In some embodiments, the filament dry box may be able to store filament spools with different sizes. In various embodiments, the filament dry box may be able to store filament spools by weight ranging from, for example, 0.5 Kilograms to 15 Kilograms. In some embodiments, the filament dry box may be configured with, for example, ball bearing constructions such that the filaments may be pulled out more easily.

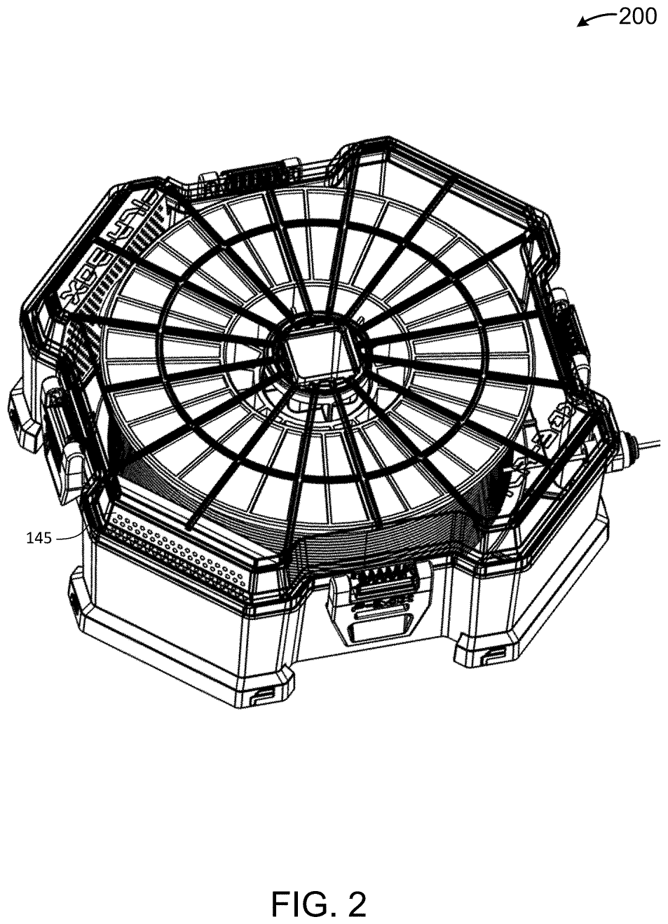

FIG. 2 shows an exemplary filament dry box with a desiccant pack. Other types of desiccants may also be used. In some embodiments, the filament dry box 100 may include a container configured to place the desiccant packs. In some embodiments, a desiccant pack having blue desiccants may be placed in the container, and the blue desiccants may turn to pink when wet. In some embodiments, a desiccant pack having orange desiccants may be placed in the container, and the orange desiccants may turn to green when wet. In some embodiments, the lid of the filament dry box may be transparent, and the base of the filament dry box may be designed with other colors. For example, the base may be black, and a user may use the corresponding filament dry box to contain black filaments.

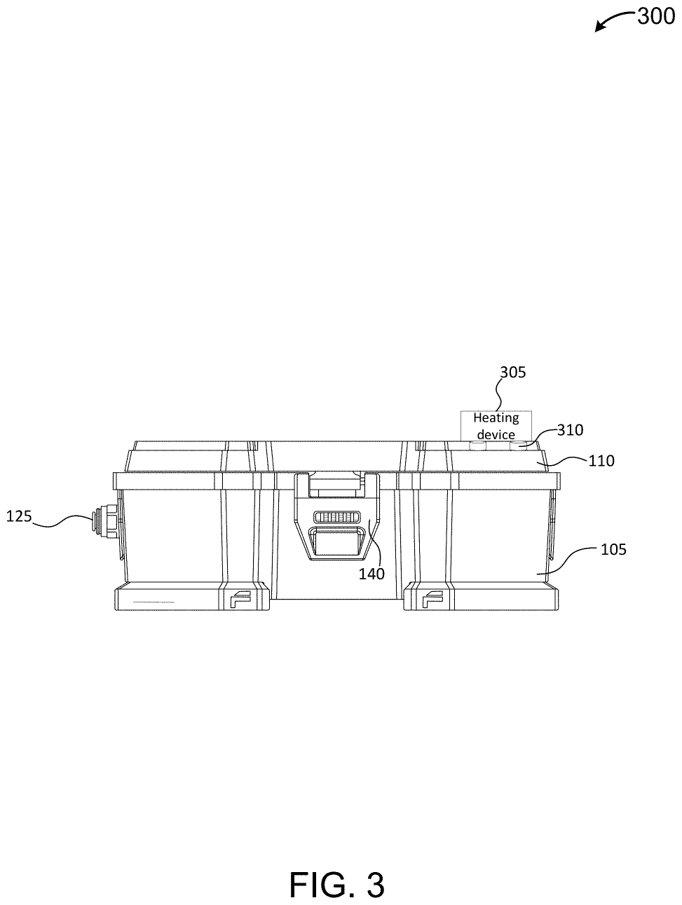

FIG. 3 depicts a front view of an exemplary filament dry box configured with an exemplary heating device. In this depicted example, the filament dry box 100 also includes a heating device 305 mounted on the top surface of the lid 110 configured to create warm air and blow (e.g., by a fan) the warm air into the box through one or more apertures (e.g., holes, array of slots) 310 on the filament dry box 100. The one or more apertures 310 may be in alignment with the fan that draws air flow cross the heating device 305 into the cavity of the filament dry box 100 in the closed state. The fan may also be used to remove moist air from the filament dry box 100 through the one or more apertures. The shape of the filament dry box 100 may allow convection currents to distribute and exchange dryer air with less dry air. The air passing through the desiccant packs may quickly become dryer. The heating device 305 may be also used in combination with the desiccants 145 to control the moisture/humidity level in the cavity of the filament dry box 100 below a predetermined moisture level, where the predetermined moisture level may be determined based on, for example, the moisture specifications of the filament to enhance the usability of the filament. In some embodiments, the heating device 305 may be directly applied or attached to the desiccant packs. The rising heat through the desiccant packs my generate significant convection currents. In some embodiments, the heat generated by the heating device 305 alone may provide enough convection to eliminate the need for a fan to distribute the air inside the housing of the filament dry box 100. In some embodiments, the warming of the air inside the housing of the filament dry box 100 may also allow more moisture to become suspended in air. In some embodiments, the filament dry box 100 may also use an internal silicon mat, a Kapton-type heater pad or element. The provided heat may alone release moisture from the filament in the box 100. Adding heat to the chamber of the filament dry box 100 may advantageously accelerate and improve the ability of the desiccant to remove moisture from the filament.

In some embodiments, the heating device 305 may be mounted to other surfaces of the filament dry box 100. In some embodiments, the heating device 305 may be placed external and piped in through the aperture via a flexible hose or a duct. In some embodiments, the heating device 305 may be placed in the filament dry box 100. The heating device 305 may include a blow dryer or a heat gun. In some embodiments, the heating device 305 may be snapped into the lid 110 of the filament dry box 100. By using the heating device, the filament placed inside the filament dry box 100 may be dried at an accelerated rate.

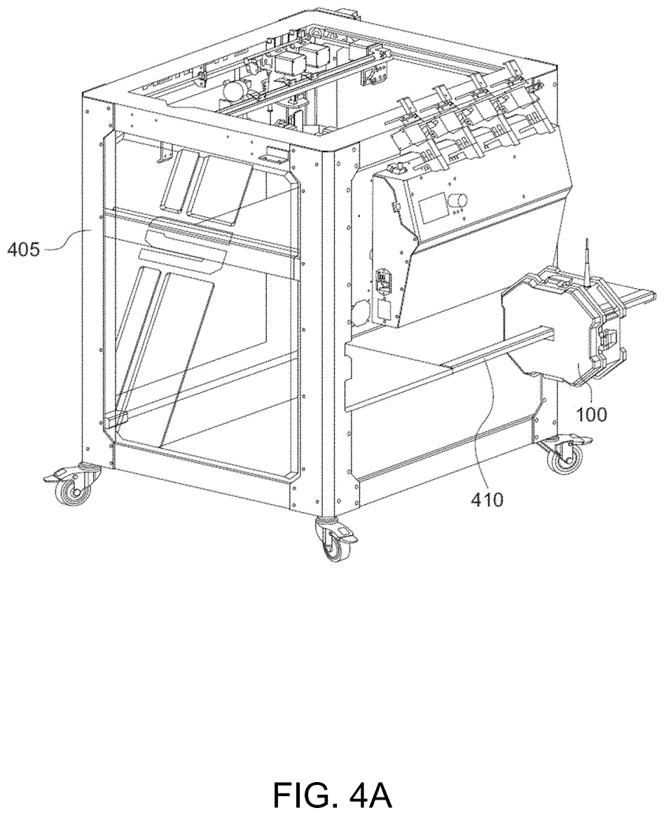

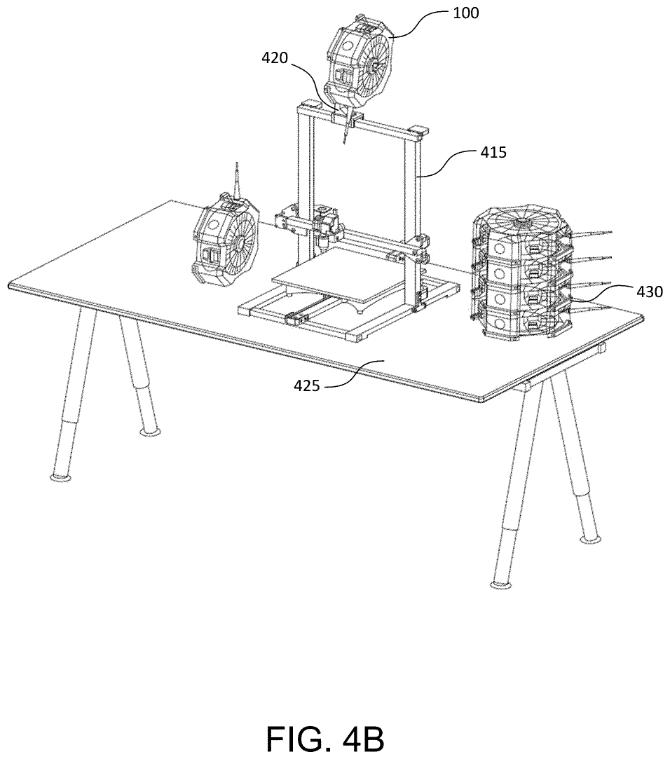

FIG. 4A depicts the exemplary filament dry box mounted on an exemplary 3D printer. In the exemplary embodiment, an exemplary 3D printer 405 (e.g., S4 printer, commercially available from STACKER Corporation, Minneapolis, Minn., USA) may form 3D objects using a string-type filament. The 3D printer 405 also includes a filament spool holder 410. The filament dry box 100 is mounted to the 3D printer 405 through a filament spool holder 410. The filament spool holder 410 may be coupled to a hub (e.g., the hub 120) of the filament dry box 100 through a square hole (e.g., the square hole 135) on the filament dry box 100. In this depicted example, the filament may feed upward into a filament drive, and then onward towards hot ends of the 3D printer 405. By providing the filament dry box 100 with a hub that is compatible with the spool holder of the 3D printer, the filament dry box 100 may be mounted in situ on the 3D printer 405 such that less moisture may be introduced during the dispensing process, as the distance between the filament dry box 100 and the 3D printer are shortened.

FIG. 4B depicts the exemplary filament dry box mounted on another exemplary 3D printer, with exemplary filament dry boxes stacked up. In this depicted example, the filament dry box 100 is mounted to a simplified DIY or hobby type 3D printer 415 through a filament spool holder 420. The spool holder 420 may include a spindle extending substantially horizontally from the spool holder 420 to support the filament dry box 100 (e.g., via square hole 135). The spindle may, for example, be non-radially uniform (e.g., square) such that the spindle rotatably couples to the filament dry box 100 to advantageously act as an orientation maintaining mechanism that inhibits rotation of the dry box as the filament is dispensed. As depicted in FIG. 4B, the filament dry box 100 is mounted on the top feeding the filament downward.

As depicted in FIG. 4C, an additional filament dry box 100 is resting on the same table as the 3D printer and may, for example, have filament extended and coupled to a filament drive system such that the filament feed upwards and over to the filament drive. In some embodiments, multiple filament dry boxes may be stacked up for compact and secure storage. For example, four filament dry boxes are stacked up on the right side of table 425. Even when the multiple filament dry boxes are stacked up, because of the see-through characteristic of the filament dry box (e.g., transparent material used to form the filament dry box), a user may also be able to identify the filament in the filament dry boxes easily (e.g., identify the type of filament, the brand of filament, and how much filament spool is left in the filament dry boxes). As depicted, each filament dry box 100 is provided with a plurality of feet 430 (e.g., on a base 105) configured to releasably interlock with mating geometry of a lid (e.g., 110) of another filament dry box 100 when the filament dry boxes are stacked.

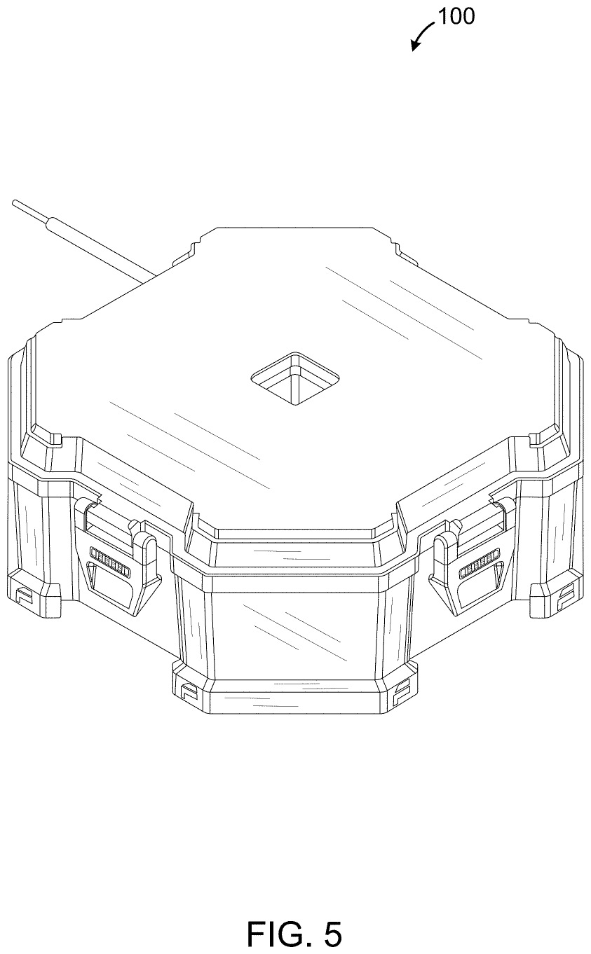

FIG. 5 is a front, top and right perspective view of the filament dry box showing the new design.

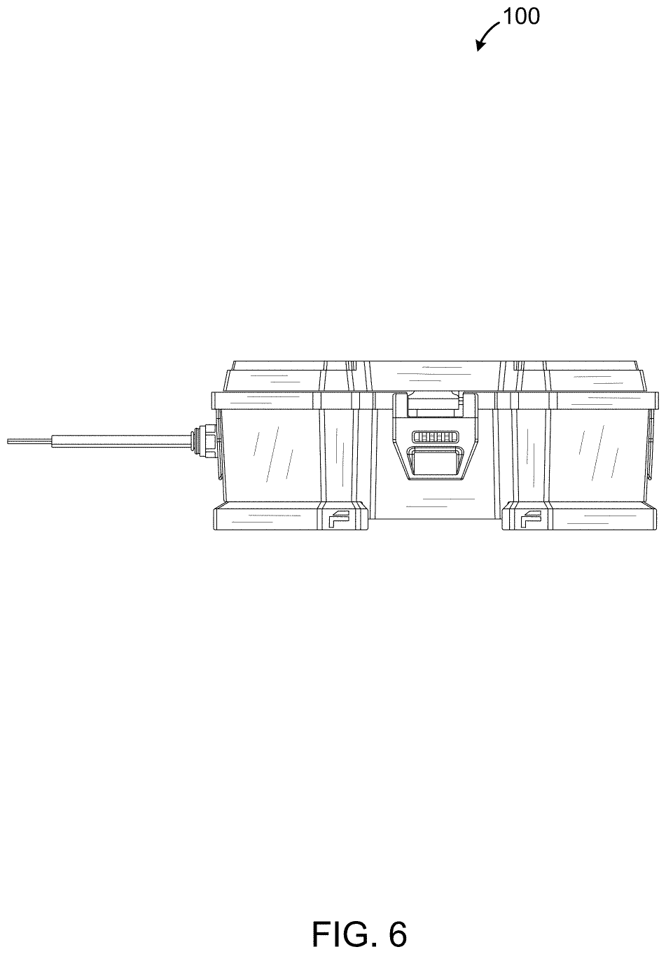

FIG. 6 is a front elevation view of the filament dry box of FIG. 5.

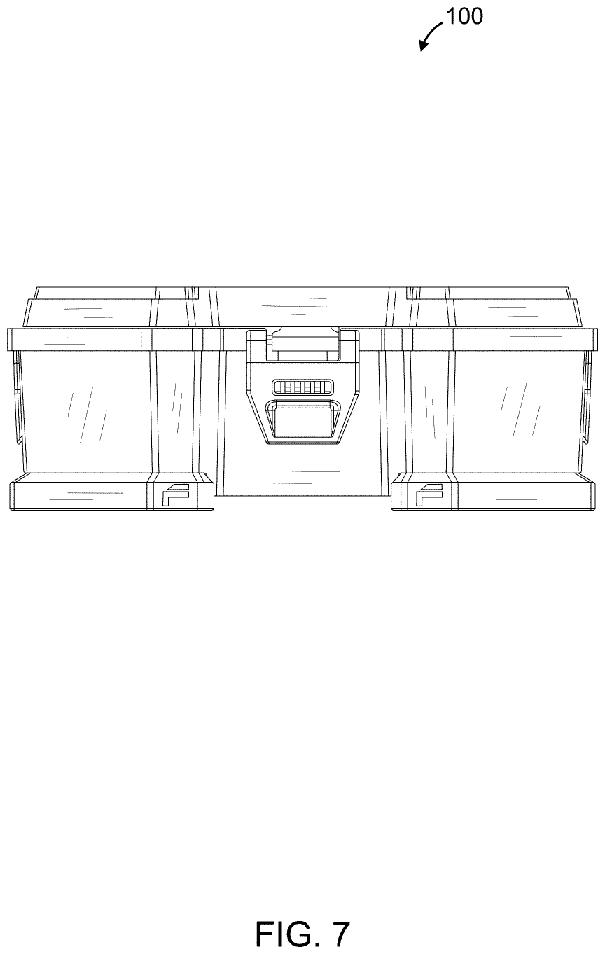

FIG. 7 is a right side elevation view of the filament dry box of FIG. 5.

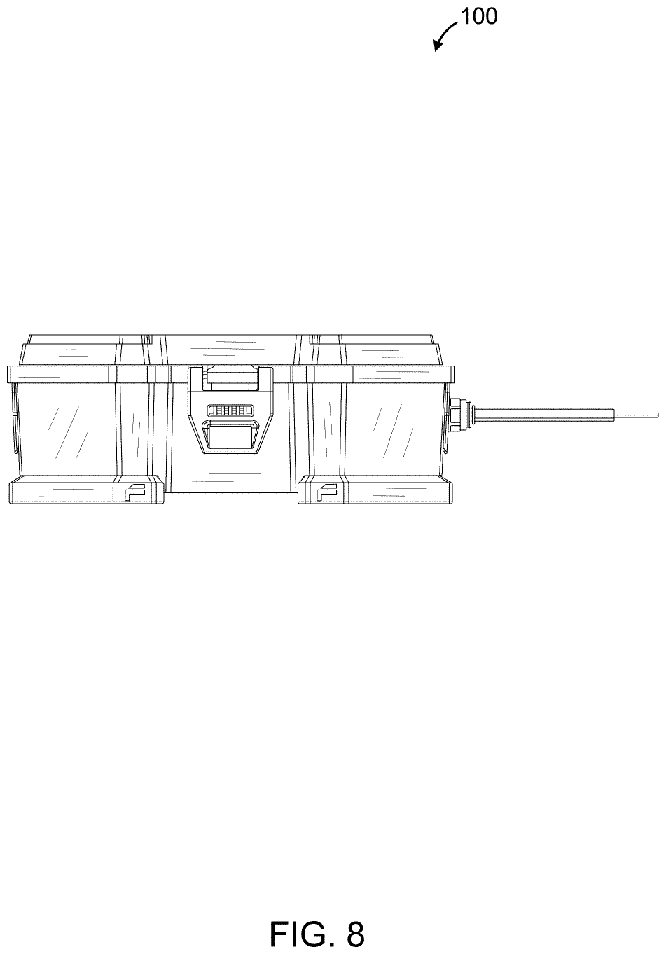

FIG. 8 is a back side elevation view of the filament dry box of FIG. 5.

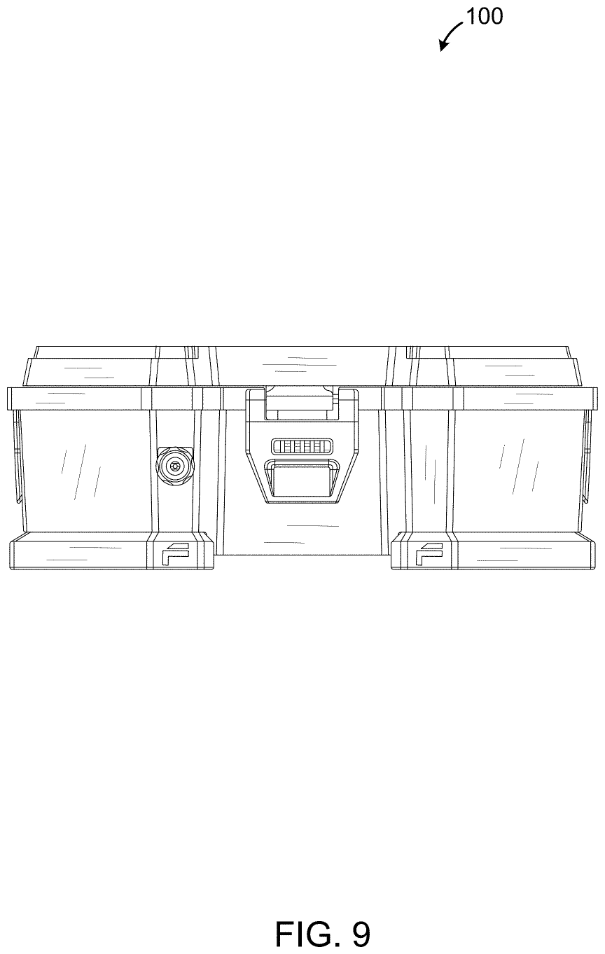

FIG. 9 is a left side elevation view of the filament dry box of FIG. 5.

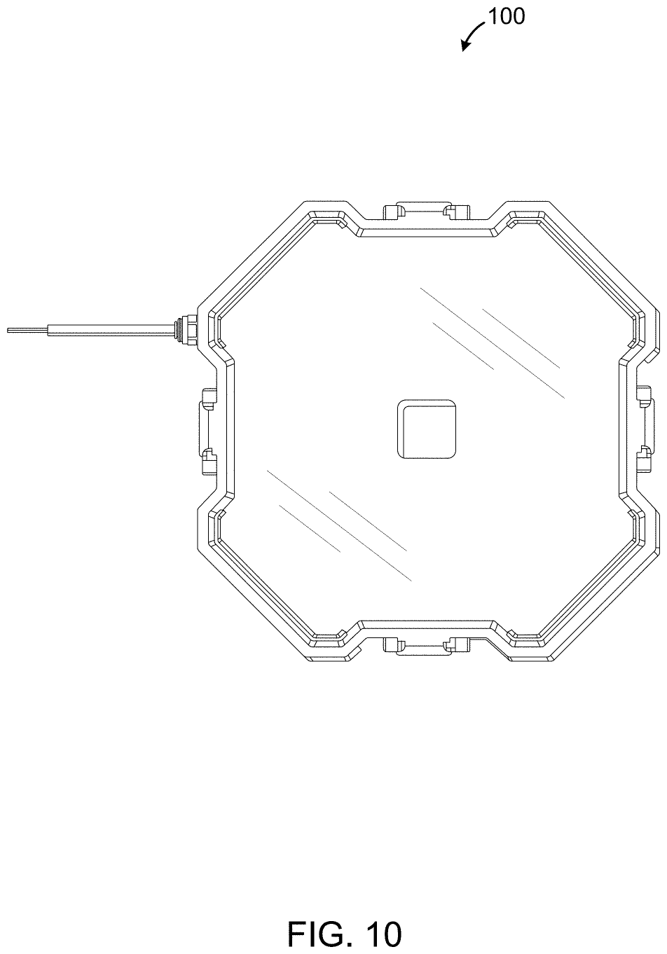

FIG. 10 is a top plan view of the filament dry box of FIG. 5.

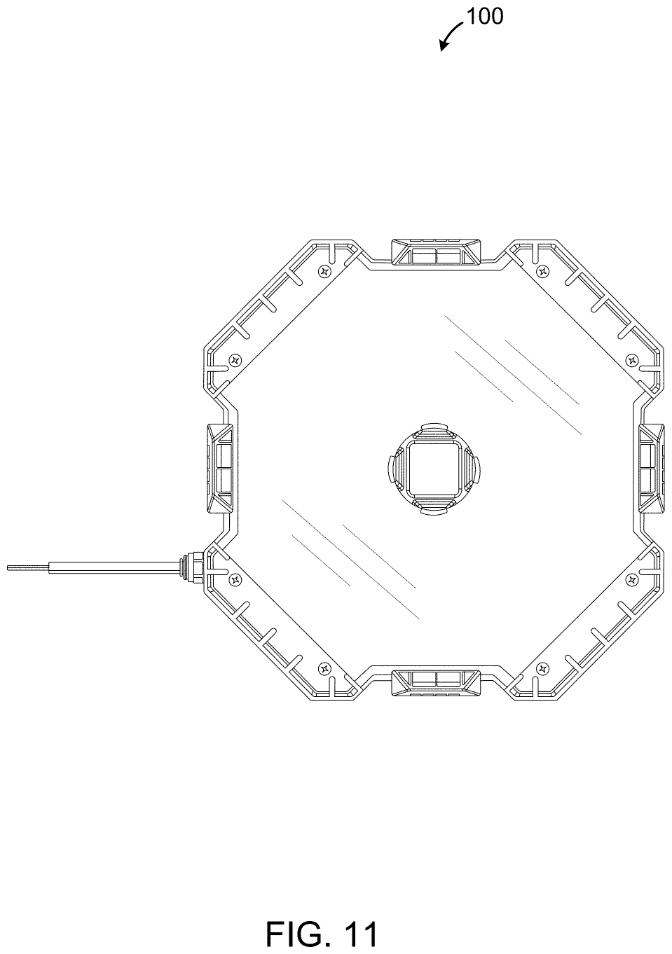

FIG. 11 is a bottom plan view of the filament dry box of FIG.5.

FIG. 12 depicts a front elevation view of another exemplary filament dry box having a built-in desiccant recharging system in a closed state. In this depicted example, another exemplary filament dry box 1200 may be constructed in a way that allows a user to recharge the desiccant directly inside the chamber of the filament dry box 1200. The user may not need to remove the desiccant from a filament dry box and dry it in another device. The temperature to recharge the desiccants may be too hot for the filament and filament spools. A user may temporarily remove the filament in the filament dry box 1200 and then increase the heat on the desiccants to 120° C. or a higher temperature. The shape of the filament dry box 1200 (and the filament dry box 100) and the location of the desiccants (e.g., at the corner of the filament dry box) may allow significant convection air flows if heat is applied to the desiccant pack areas. In some embodiments, the main housing of the filament dry box may be primarily made from metal or other materials that can handle heat high enough for efficient drying or recharging of the desiccants. The locations of the desiccant packs may promote strong convection currents in a circulatory path (shown in FIG. 15), potentially eliminating the need for a circulation fan. In some embodiments, heat may be directly applied to the desiccant packs or near the desiccant packs. In some embodiments, the filament dry box may include, for example, baffles or valves to allow humid air to escape. In some embodiments, the chamber of the filament dry box may be partially opened (e.g., opening the lid of the filament dry box) to allow humid air to escape. Once the desiccants are recharged, the user may adjust the heating device into a lower heat mode and refill the filament dry box with filament. The low heat and freshly dried desiccant may advantageously keep the filament dry for, for example, several months.

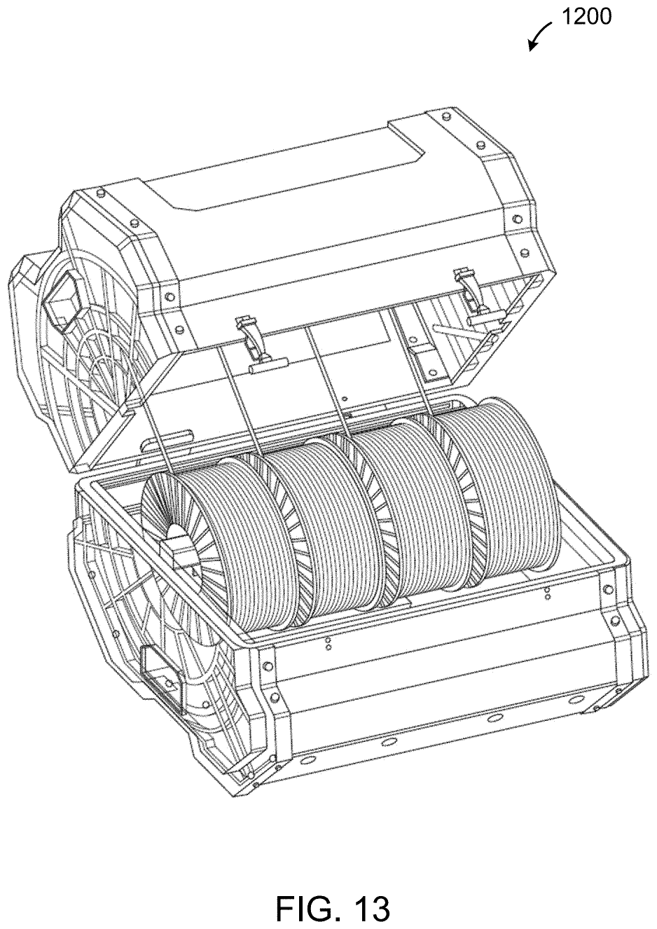

FIG. 13 is a front, top, and right perspective view of the exemplary filament dry box described with reference to FIG. 12. In this depicted example, the filament is resting on a rod or a support bracket. Various sizes of the filament may be contained in the filament dry box 1200. In some embodiments, the filament dry box 1200 may be customized to accept more than one filament spool.

The filament dry box 1200 may be split in half to open. The user may temporarily remove the filament in the filament dry box 1200 and then increase the heat on the desiccants to 120° C. or a higher temperature. In this depicted example, the desiccants (in a desiccant canister) are located in the lower left compartment. Other locations (e.g., any of the four compartments) may also be used to place the desiccant canister. A heating device may be arranged under the desiccant canister. In some embodiments, the heating device may be a heating pad. The heating pad may be made from, for example, etched foil, wire wound, or ceramic type heating elements. In some embodiments, the heating device may generate hot air to the desiccant canister. In some embodiments, the filament dry box 1200 may also include a hole or a hub similar to the hole 135 of the filament dry box 100. The hub used by the filament dry box 1200 may include two halves and sealed with a gasket.

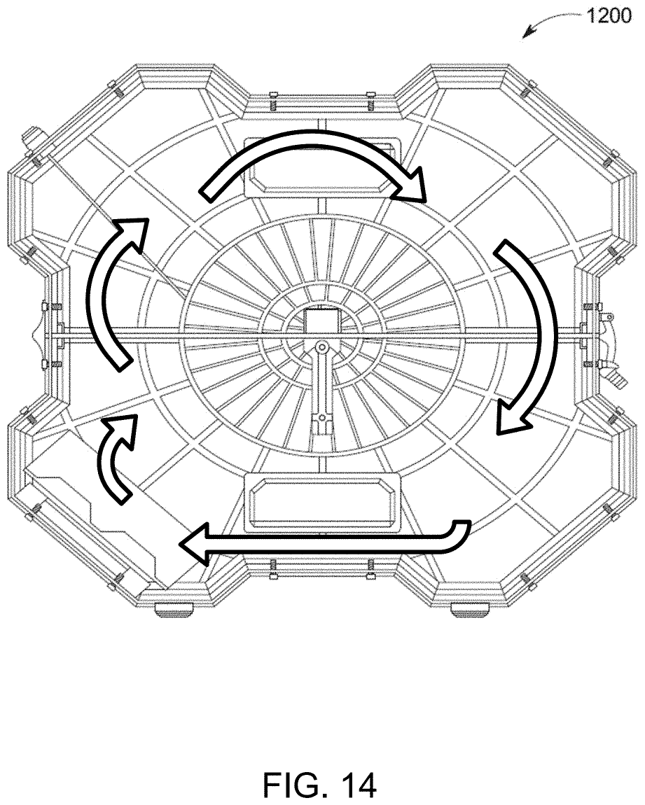

FIG. 14 depicts an exemplary circulatory path in the exemplary filament dry box described with reference to FIG. 12.

Although various embodiments have been described with reference to the figures, other embodiments are possible. For example, when mounted on a 3D printer (e.g., as shown in FIGS. 4A-4B), a filament dry box (e.g., box(es) 100 at least as described in relation to FIGS. 4A-4B) may be placed in a predetermined orientation depending on the location of the spool holder of the 3D printer. In some embodiments, the shape of the hole 135 may be designed as, for example, triangle, hexagonal, or irregular (e.g., D-shape), to be compatible with the filament spool holder of the 3D printer.

Various embodiments may, for example, include features to maintain orientation of the filament dry box (e.g., filament dry box 100, at least as described in reference to FIGS. 4A-4B) during dispensing operations. For example, when dispensing filament to an operating 3D printer (e.g., when a filament extending from a filament dry box 100 is engaged with a filament deposition head in 3D printers 405 or 415 in the exemplary use-case scenarios depicted in FIGS. 4A-4B), one or more orientation maintaining mechanisms may be configured to maintain a desired orientation of the filament dry box relative to the 3D printer or a feature thereof.

In various embodiments, the orientation maintaining mechanism may include a lumen having an axial cross-section which is non-radially uniform. For example, a non-circular coupling (e.g., a spindle) may slidingly engage a mating internal lumen of the filament dry box (e.g., square hole 135 at least as described in relation to FIG. 1). In various embodiments, various non-circular three-dimensional lumen cross-sectional profiles may include, by way of example and not limitation, ellipsoid, star, hex, teardrop, symmetrical or asymmetrical, at least one vertex, triangular, rectangular, D-shape, a circular profile having at least one flat side, or some combination thereof. In various embodiments, a spindle may have a mating or otherwise complementary cross-sectional profile such that when a spindle is slidingly engaged within the lumen, the spindle releasably engages with the lumen to limit or prevent rotation of the filament dry box about the spindle during dispensing of the filament from the filament dry box. Various such embodiments may advantageously limit or prevent relative rotation between a support shaft and filament dry box.

In various embodiments, an orientation maintaining mechanism may include preventing rotation by engaging an exterior surface of the base and/or the lid. Such mechanisms include, by way of example and not limitation, a feature protruding from an exterior surface of the filament dry box, a clamp, a mating surface, or some combination thereof. For example, by engaging an exterior of the filament dry box to inhibit rotation during dispensing operations, some embodiments may advantageously be enabled to use a round support axle. In some embodiments, by way of example and not limitation, a spindle may be provided with a shelf (e.g., below the spindle) configured to engage a flat surface of the dry box such that rotation of the dry box relative to the spindle is limited or prevented. For example, in various embodiments, a friction mechanism (e.g., a rubber fitment element) may be configured to fit over a spindle (e.g., a round spindle), and within a lumen of the filament. The friction mechanism may be longitudinally shaped (e.g., tapered) such that axial advancement of the friction mechanism and/or spindle into the lumen radially compresses the friction mechanism, thereby releasably coupling the filament dry box to the spindle.

A number of implementations have been described. Nevertheless, it will be understood that various modifications may be made. For example, advantageous results may be achieved if the steps of the disclosed techniques were performed in a different sequence, or if components of the disclosed systems were combined in a different manner, or if the components were supplemented with other components. Accordingly, other implementations are contemplated within the scope of the following claims.

What is claimed is:

1. A filament dispensing apparatus comprising:
a base and a lid hingedly coupled together and configured to releasably couple together to define a first cavity configured to receive a spool of filament for deposition;
a first sealing element disposed between the base and the lid and configured such that, when the base and lid releasably couple together, the first sealing element sealingly connects them to substantially inhibit fluid communication between the first cavity and an ambient atmosphere external to the base and the lid;
at least one desiccant cartridge releasably engaged within the first cavity; and,
a first aperture into the first cavity configured to allow egress of the filament from the first cavity,
wherein the base and the lid define a lumen passing through the first cavity substantially along an axis of rotation of the spool, the lumen having an axial cross-section which is non-radially uniform such that it rotationally couples the apparatus to a spindle when the spindle is slidingly engaged in the lumen axial cross-section.

2. The apparatus of claim 1, wherein the at least one desiccant cartridge comprises a plurality of desiccant cartridges releasably engaged in a corresponding plurality of corners of the first cavity, the corners being substantially equidistant from the axis of rotation of the spool.

3. The apparatus of claim 1, wherein:
each of the at least one desiccant cartridges comprises a plurality of housing elements configured to releasably couple together and define a second cavity, and
at least one of the plurality of housing elements further comprises a plurality of apertures providing fluid communication between the first cavity and the second cavity when the corresponding desiccant cartridge is disposed within the first cavity.

4. The apparatus of claim 1, further comprising a second sealing element substantially occluding the first aperture and configured to slidingly engage the filament during egress from the cavity such that air is substantially excluded from ingress into the first cavity through the first aperture.

5. The apparatus of claim 1, wherein at least one of the lid and the base are transparent.

6. The apparatus of claim 1, further comprising a plurality of feet on an outer surface of the base, wherein the plurality of feet and the lid are configured to releasably engage such that a second plurality of feet provided on a second base of a second apparatus releasably engage the lid when stacked thereon.

7. A filament dispensing apparatus comprising:
a base and a lid configured to releasably couple together to define a first cavity configured to receive a spool of filament for deposition;
a first sealing element disposed between the base and the lid and configured such that, when the base and lid releasably couple together, the first sealing element sealingly connects them to substantially inhibit fluid communication between the first cavity and an ambient atmosphere external to the base and the lid;
at least one desiccant cartridge releasably engaged within the first cavity; and,
a first aperture into the first cavity configured to allow egress of the filament from the first cavity,
wherein the base and the lid define a lumen passing through the first cavity substantially along an axis of rotation of the spool.

8. The apparatus of claim 7, wherein an axial cross-section of the lumen is radially non-uniform such that the lumen rotationally couples the apparatus to a spindle when the spindle is slidingly engaged in the lumen axial cross-section.

9. The apparatus of claim 8, wherein the axial cross-section has at least one vertex.

10. The apparatus of claim 7, wherein at least one of the lid and the base are transparent.

11. The apparatus of claim 7, wherein the at least one desiccant cartridge comprises a plurality of desiccant cartridges releasably engaged in a corresponding plurality of corners of the first cavity, the corners being substantially equidistant from the axis of rotation of the spool.

12. The apparatus of claim 7, wherein:
each of the at least one desiccant cartridges comprises a plurality of housing elements configured to releasably couple together and define a second cavity, and
at least one of the plurality of housing elements further comprises a plurality of apertures providing fluid communication between the first cavity and the second cavity when the corresponding desiccant cartridge is disposed within the first cavity.

13. The apparatus of claim 7, further comprising a second sealing element substantially occluding the first aperture and configured to slidingly engage the filament during egress from the cavity such that air is substantially excluded from ingress into the first cavity through the first aperture.

14. The apparatus of claim 7, further comprising at least one coupling element configured to releasably couple the lid and the base together.

15. The apparatus of claim 7, further comprising at least one hinge element configured to rotatably couple the lid and the base together.

16. The apparatus of claim 7, wherein the first cavity is configured to receive a plurality of spools.

17. The apparatus of claim 7, further comprising a plurality of feet on at outer surface of at least one of the base and the lid, the feet being configured to support the apparatus when placed on a supporting surface.

18. The apparatus of claim 17, wherein the plurality of feet are provided on an outer surface of the base, and the plurality of feet and the lid are configured to releasably engage such that a second plurality of feet provided on a second base of a second apparatus releasably engage the lid when stacked thereon.

19. A filament dispensing apparatus comprising:
a base and a lid configured to releasably couple together to define a first cavity configured to receive a spool of filament for deposition;
a first sealing element disposed between the base and the lid and configured such that, when the base and lid releasably couple together, the first sealing element sealingly connects them to substantially inhibit fluid communication between the first cavity and an ambient atmosphere external to the base and the lid;
a first aperture into the first cavity configured to allow egress of the filament from the first cavity; and,
means for maintaining orientation of the apparatus while the filament is dispensed from the first cavity.

20. The filament dispensing apparatus of claim 19, wherein the means for maintaining orientation of the apparatus comprises a lumen passing through the first cavity substantially along an axis of rotation of the spool, the lumen having a non-radially uniform cross-section.
